(19) United States
(12) Patent Application Publication
(10) Pub. No.: US 2020/0413489 A1
(43) Pub. Date: Dec. 31, 2020

(54) NEMA EDGE GATEWAY

(71) Applicant: Agileiots Investment Co., Ltd., Taoyuan City (TW)

(72) Inventor: HUNG-HSIANG CHIANG, Kaohsiung City (TW)

(21) Appl. No.: 16/911,201

(22) Filed: Jun. 24, 2020

(30) Foreign Application Priority Data
Jun. 28, 2019 (TW) 108123014

(51) Int. Cl. H04W 88/16; H05B 47/18; H04L 12/10

(52) U.S. Cl. CPC H04W 88/16; H04W 16/18; H04L 12/10; H05B 47/18

(57) ABSTRACT

A NEMA edge gateway is provided, which can be connected to a mobile communication network and can be used with a NEMA Luminaire of an existing streetlight to receive electrical energy from circuitry of the streetlight. The NEMA edge gateway can provide networking and power for a serial device and an IP device respectively, making both of them operate smoothly and able to be networked, and thereby expanding IoT applications. This is also to resolve difficulty in finding locations for placing gateways in order to greatly increase the number of gateways built in urban areas and fulfill increasing local communication service requirements.

### CROSS-REFERENCE TO RELATED APPLICATIONS

This application claims the priority of Republic of China Patent Application No. 108123014 filed on Jun. 28, 2019, in the State Intellectual Property Office of the R.O.C., the disclosure of which is incorporated herein by reference.

### BACKGROUND OF THE INVENTION

### Field of the Invention

The present invention relates to communication facility fields, and more particularly, to a NEMA edge gateway that can be used with a NEMA Luminaire of an existing streetlight.

### Descriptions of the Related Art

5G technology is booming globally, and it is expected that 5G is networked to everything in the future. Telecommunications providers have greatly upgraded current 4G (LTE) technology and widely applied Internet of Things (IoT) to infrastructures, supply chain logistics, asset management, environmental monitoring, etc.

Nowadays using mobile phones is so popular with mature and multiple 4G services being provided. For example, it is very convenient that people can use their mobile phones to check bus arriving timetables for nearby bus stops or look up estimated waiting time for their doctor appointments. The innovation of 5G technology leads to broad application of networking and IoT, such that IoT deployment becomes important. IoT deployment usually requires gateway devices to serve as common access points for different levels of networks such as local area network (LAN) and wide area network (WAN). It however becomes very difficult for the telecommunications providers to find where to locate the gateway devices as urban public land is getting less and less due to rapid urban development.

It is an important task in the art to find locations for placing gateways to greatly increase the number of gateways provided in urban areas and fulfill increasing local communication service requirements.

### SUMMARY OF THE INVENTION

In view of the above drawbacks in the prior art, a primary object of the present invention is to provide a NEMA edge gateway, which can be mounted on a NEMA Luminaire of a streetlight and can provide networking and power for a serial device and an IP device respectively, so as to allow both the serial device and the IP device to operate smoothly and to be networked, thereby expanding applications of the Internet of Things (IoT).

To achieve the above and other objects, a NEMA edge gateway is provided in the invention, the NEMA edge gateway is for being used with a NEMA Luminaire, a serial device and an IP device, including: a NEMA motherboard including a NEMA port for being coupled to the NEMA Luminaire and electrically connected to the serial device; a Power Over Serial (POS) module mounted on the NEMA motherboard and electrically connected to the NEMA port, and for providing networking and power for the serial device via the NEMA port; a mobile communication network module for providing a mobile communication network; a Power Over Ethernet (POE) module for being coupled to the IP device and for providing networking and power for the IP device; and a network processing module electrically connected to the mobile communication network module, the POE module and the POS module, and for allowing the mobile communication network module to provide the mobile communication network for the POE module and the POS module.

Preferably, in the NEMA edge gateway said above, wherein further including: a streetlight dimming control module mounted on the NEMA motherboard and electrically connected to the NEMA port, and for controlling brightness of the NEMA Luminaire via the NEMA port.

Preferably, in the NEMA edge gateway said above, wherein further including: a power supply module electrically connected to the NEMA port to receive electrical energy, wherein the electrical energy serves as a power source for the streetlight dimming control module, the POS module, the mobile communication network module, the POE module and the network processing module.

Preferably, in the NEMA edge gateway said above, wherein further including: a network status indicating module electrically connected to the network processing module and for displaying a status of the network processing module or mobile communication network.

Preferably, in the NEMA edge gateway said above, wherein further including: an encryption and decryption module electrically connected to the network processing module and for performing encryption and decryption on signals processed by the network processing module.

Preferably, in the NEMA edge gateway said above, wherein the network processing module includes a clock synchronization unit for performing clock synchronization on signals processed by the network processing module.

Preferably, in the NEMA edge gateway said above, wherein the mobile communication network module includes a positioning module for providing positioning information for the network processing module.

Preferably, in the NEMA edge gateway said above, wherein the mobile communication network module, the network processing module and the POE module are mounted on the NEMA motherboard.

Preferably, in the NEMA edge gateway said above, wherein further including: a POE daughterboard, wherein the POE module is mounted on the POE daughterboard.

Preferably, in the NEMA edge gateway said above, wherein including: a NEMA base and a NEMA case, wherein the NEMA base carries the NEMA motherboard; the NEMA port has a coupling end exposed from the NEMA base and for being coupled to the NEMA Luminaire; and the NEMA case covers the NEMA base, and the NEMA motherboard and the POE daughterboard are stacked in layers within a receiving space formed between the NEMA case and the NEMA base.

Preferably, in the NEMA edge gateway said above, wherein further including: a network daughterboard, wherein the mobile communication network module and the network processing module are mounted on the network daughterboard.

Preferably, in the NEMA edge gateway said above, wherein further including: a POE daughterboard and a network daughterboard, wherein the network processing module and the POE module are mounted on the POE daughterboard, and the mobile communication network module is mounted on the network daughterboard.

Preferably, in the NEMA edge gateway said above, wherein further including: a NEMA base and a NEMA case, wherein the NEMA base carries the NEMA motherboard; the NEMA port has a coupling end exposed from the NEMA base and for being coupled to the NEMA Luminaire; and the NEMA case covers the NEMA base, and the NEMA motherboard, the network daughterboard and the POE daughterboard are stacked in layers within a receiving space formed between the NEMA case and the NEMA base.

In summary, the NEMA edge gateway of the present invention can be connected to a mobile communication network and can be used with a NEMA Luminaire of an existing streetlight to receive electrical energy from circuitry of the streetlight. Thus, the NEMA edge gateway can provide networking and power for a serial device and an IP device respectively, making both of them operate smoothly and able to be networked, and thereby broadening IoT applications. This is also to resolve difficulty in finding locations for placing gateways in order to greatly increase the number of gateways built in urban areas and fulfill increasing local communication service requirements.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is basic system architectural block diagrams of a NEMA edge gateway according to the first embodiment of the present invention.

FIG. 2 is basic system architectural block diagrams of a NEMA edge gateway according to the second embodiment of the present invention.

FIG. 3 is basic system architectural block diagrams of a NEMA edge gateway according to the third embodiment of the present invention.

FIG. 4 is basic system architectural block diagrams of a NEMA edge gateway according to fourth embodiment of the present invention.

FIG. 5 is schematic diagrams showing a usage status of applying the NEMA edge gateway to a street light according to the present invention.

FIG. 6 is schematic breakdown diagrams showing a usage status of applying the NEMA edge gateway to a street light according to the second embodiment of the present invention.

FIG. 7 is schematic breakdown diagrams showing a usage status of applying the NEMA edge gateway to a street light according to the third and fourth embodiments of the present invention.

FIGS. 7-1 is schematic breakdown sectional diagrams showing a usage status of applying the NEMA edge gateway to a street light according to the third and fourth embodiments of the present invention.

FIGS. 7-2 is schematic combination diagrams showing a usage status of applying the NEMA edge gateway to a street light according to the third and fourth embodiments of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

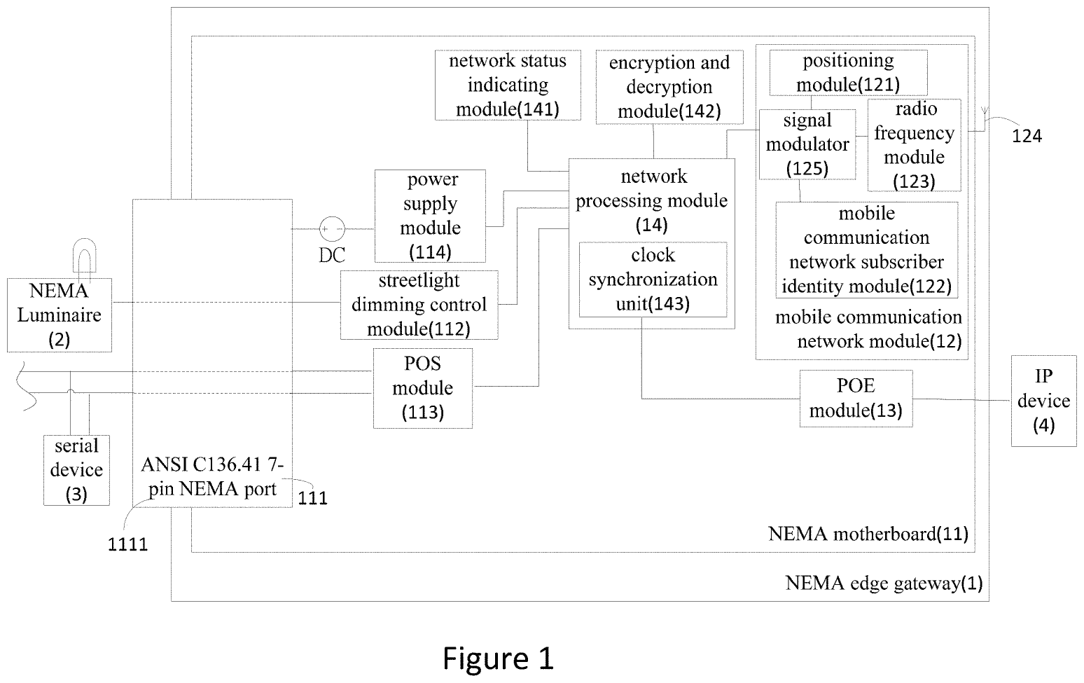

The present invention provides a NEMA edge gateway, which is described below according to its preferred embodiments with reference to FIGS. 1 to 7-2.

In order to make the disclosure more concise and easier to understand, the same or similarly functioning elements in the following embodiments will be described with the same symbols, and the description of the same or equivalent features will be omitted.

As shown in FIG. 1, the NEMA edge gateway 1 can be used with a NEMA Luminaire 2 of an existing streetlight, a serial device 3 (such as a sensor) and an IP device 4 (such as an IP camera). The NEMA edge gateway 1 includes: a NEMA motherboard 11, a streetlight dimming control module 112, a Power Over Serial (POS) module 113, a power supply module 114, a mobile communication network module 12, a Power Over Ethernet (POE) module 13 and a network processing module 14.

The NEMA motherboard 11 includes a NEMA port 111 such as ANSI C136.41 7-pin NEMA port. The NEMA port 111 can be coupled to the NEMA Luminaire 2 of the streetlight and electrically connected to the serial device 3, allowing the power supply module 114 to receive electrical energy from circuitry of the streetlight, wherein the electrical energy serves as a power source provided for operation of the streetlight dimming control module 112, POS module 113, mobile communication network module 12, POE module 13 and network processing module 14.

The mobile communication network module 12 can be electrically connected to the network processing module 14 to provide a mobile communication network (such as NB-IOT, 4G or 5G) for the network processing module 14. The mobile communication network module 12 includes a positioning module 121, a mobile communication network subscriber identity module 122, a radio frequency module 123, an antenna module 124 and a signal modulator 125. The positioning module 121 is, for example, Global Positioning System (GPS) that can provide positioning information for the network processing module 14. The mobile communication network module 12 can be integrally formed on the NEMA motherboard 11, or can be mounted on a separate circuit board other than the NEMA motherboard 11 and connected to the NEMA motherboard 11 by an interface such as Mini PCIE. The mobile communication network subscriber identity module 122 is, for example, Subscriber Identity Module (SIM) for storing subscriber identification data. The signal modulator 125 is, for example, modulator-demodulator (Modem), for modulating digital signals to analog signals or modulating analog signals to digital signals so as to allow transmission of the modulated signals.

The streetlight dimming control module 112 is mounted on the NEMA motherboard 11 and electrically connected to the NEMA port 111, and can control brightness of the NEMA Luminaire 2 via the NEMA port 111. The POS module 113 is mounted on the NEMA motherboard 11 and electrically connected to the NEMA port 111, and can provide electrical energy for operation of the serial device 3 via the NEMA port 111. The POE module 13 can be coupled to the IP device 4 to provide electrical energy for operation of the IP device 4.

The network processing module 14 is electrically connected to the mobile communication network module 12, the POE module 13 and the POS module 113 respectively. This allows the mobile communication network module 12 to provide the mobile communication network for the POE module 13 and the POS module 113 respectively, allows the POS module 113 to provide networking for the serial device 3, and allows the POE module 13 to provide networking for the IP device 4, such that the serial device 3 and the IP device 4 both can be networked when in operation, thereby expanding IoT applications.

As shown in FIGS. 1 to 4, the network processing module 14 of the NEMA edge gateway 1 includes a clock synchronization unit 143 using, for example, IEEE 1588 Precision Time Protocol (PTP), for performing clock synchronization on signals processed by the network processing module 14.

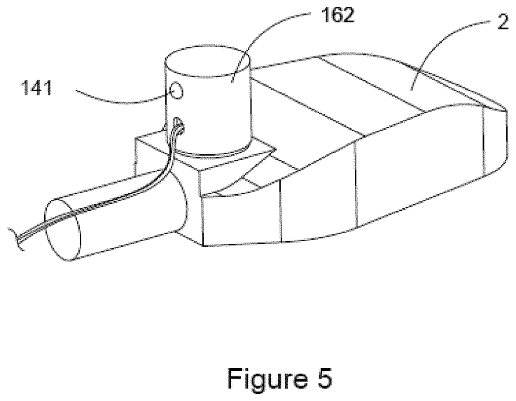

As shown in FIG. 5, the NEMA edge gateway 1 further includes a network status indicating module 141 electrically connected to the network processing module 14, for retrieving an operating status of the network processing module 14 and indicating it using, for example, a light signal, or for retrieving and indicating a status (such as speed) of the mobile communication network of the mobile communication network module 12, such that a managing person can only use the network status indicating module 141, without other detection equipment, to visually monitor the operating status of the network processing module 14 or the status of the mobile communication network.

As shown in FIGS. 1 to 4, the NEMA edge gateway 1 further includes an encryption and decryption module 142 electrically connected to the network processing module 14, for performing encryption and decryption on signals processed by the network processing module 14, to prevent the signals processed by the network processing module 14 from being hacked and thereby meet network information safety requirements.

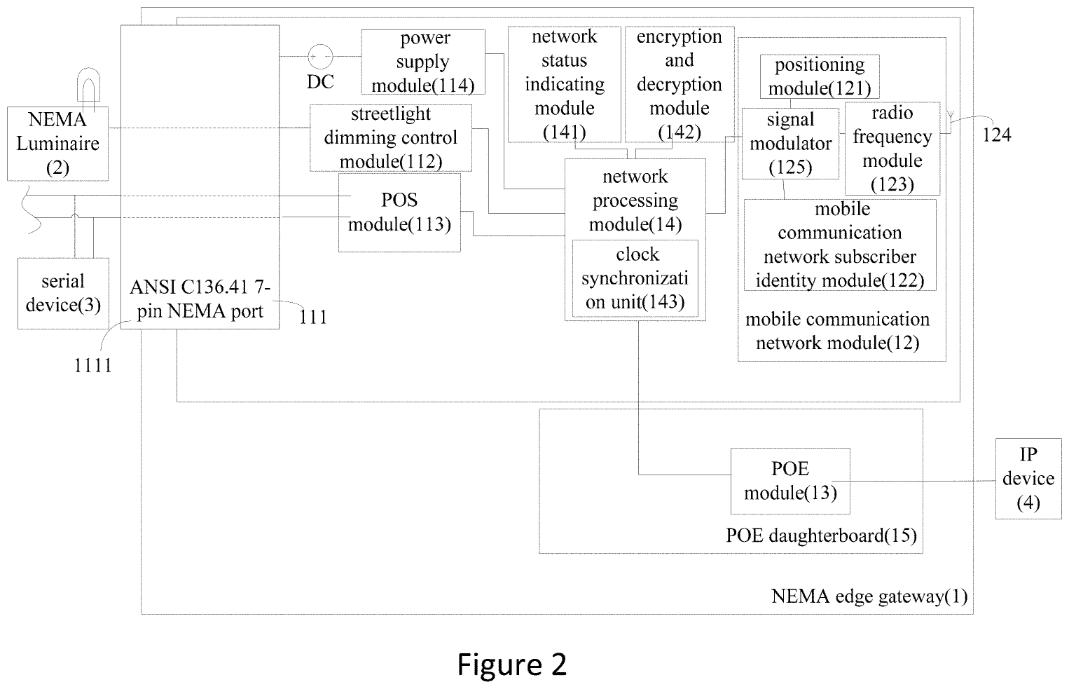

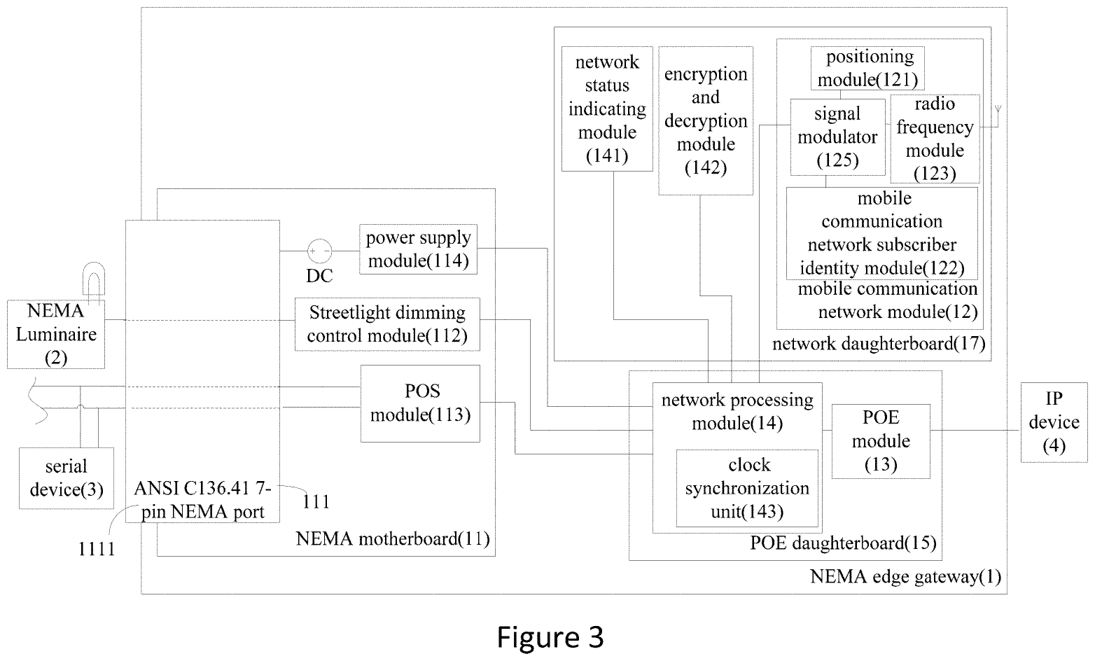

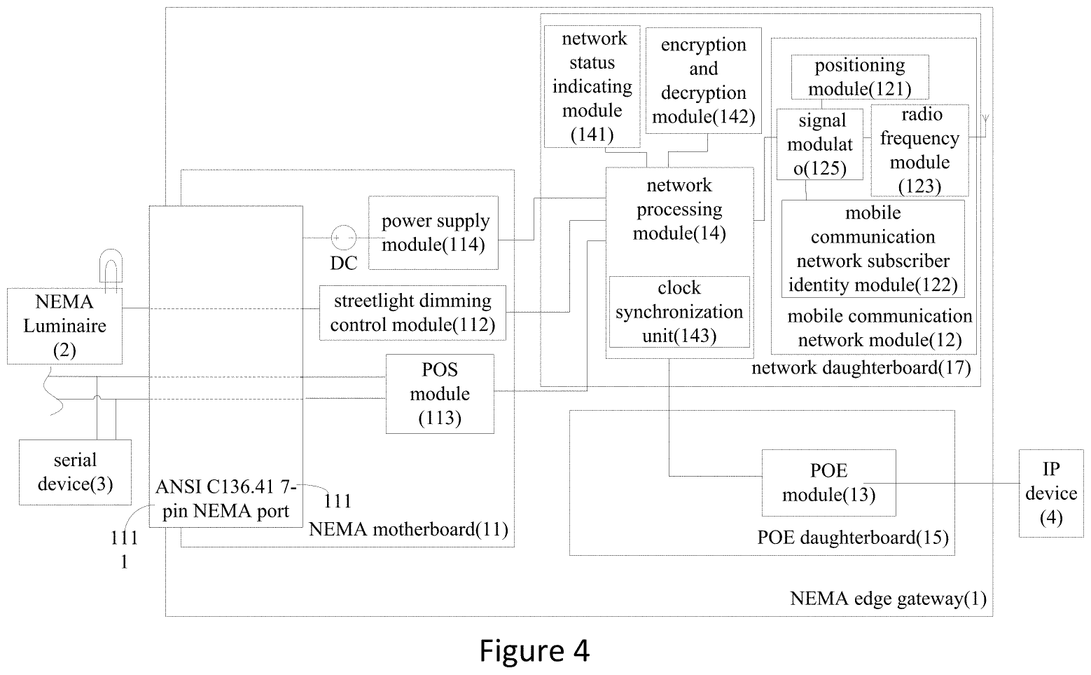

As shown in FIG. 1, the mobile communication network module 12, the POE module 13 and the network processing module 14 are mounted on the NEMA motherboard 11. This is not the only configuration. Alternatively, as shown in FIG. 2, the NEMA edge gateway 1 allows the POE module 13 to be mounted on a POE daughterboard 15 other than the NEMA motherboard 11, so as to reduce size of the NEMA motherboard 11. Alternatively, as shown in FIG. 3, the NEMA edge gateway 1 allows the network processing module 14 and the POE module 13 to be mounted on a POE daughterboard 15 other than the NEMA motherboard 11, and allows the mobile communication network module 12 to be mounted on a network daughterboard 17 other than the NEMA motherboard 11, so as to reduce size of the NEMA motherboard 11. Alternatively, as shown in FIG. 4, the NEMA edge gateway 1 allows the mobile communication network module 12 and the network processing module 14 to be mounted on a network daughterboard 17 other than the NEMA motherboard 11, so as to reduce size of the NEMA motherboard 11.

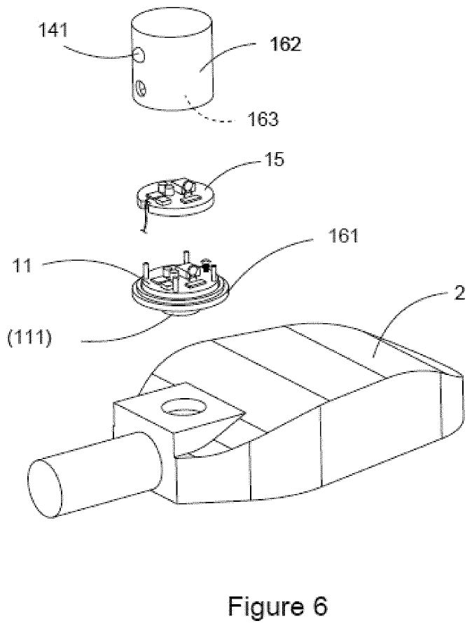

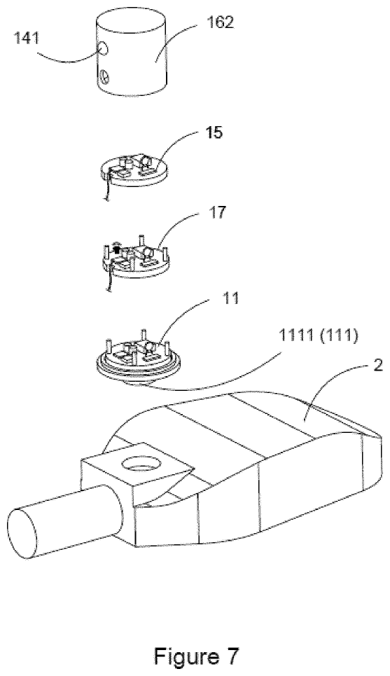

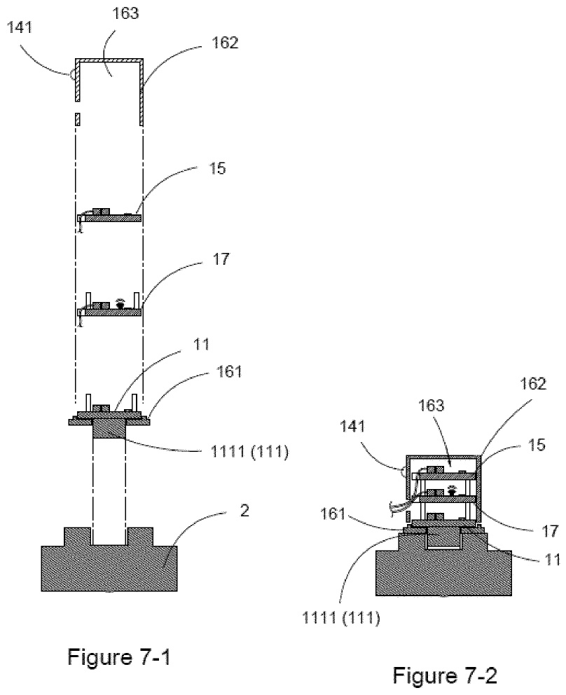

As shown in FIGS. 5 to 7-2, the NEMA edge gateway 1 further includes a NEMA base 161 and a NEMA case 162, wherein the NEMA base 161 carries the NEMA motherboard 11. The NEMA port 111 has a coupling end 1111 exposed from the NEMA base 161 and for being coupled to the NEMA Luminaire 2. The NEMA case 162 covers the NEMA base 161, with a receiving space 163 being formed between the NEMA case 162 and the NEMA base 161. As shown in FIG. 6, the NEMA motherboard 11 and the POE daughterboard 15 are stacked in layers and received in the receiving space 163 so as to reduce sizes of the NEMA base 161 and NEMA case 162. As shown in FIG. 7, the NEMA motherboard 11, the network daughterboard 17 and the POE daughterboard 15 are stacked in layers and received in the receiving space 163 so as to reduce sizes of the NEMA base 161 and NEMA case 162.

Therefore, the present invention provides a NEMA edge gateway having a standard NEMA port, which can be coupled to a NEMA Luminaire of a streetlight to receive electrical energy from circuitry of the streetlight. The NEMA edge gateway further includes a POS module and a POE module, for providing networking and power for a serial device and an IP device respectively, making both of them operate smoothly and able to be networked, and thereby expanding IoT applications.

Moreover, as streetlights are widely distributed in urban areas and the NEMA edge gateway of the present invention can be used with a NEMA Luminaire of an existing streetlight, there is no need to find other places for putting the NEMA edge gateway of the present invention. This thereby effectively resolves difficulty in finding locations for placing gateways in order to greatly increase the number of gateways built in urban areas and fulfill increasing local communication service requirements.

The examples above are only illustrative to explain principles and effects of the invention, but not to limit the invention. It will be apparent to those skilled in the art that modifications and variations can be made without departing from the scope of the invention. Therefore, the protection range of the rights of the invention should be as defined by the appended claims.

What is claimed is:

1. A NEMA edge gateway for being used with a NEMA Luminaire, a serial device and an IP device, including:
a NEMA motherboard including a NEMA port for being coupled to the NEMA Luminaire and electrically connected to the serial device;
a Power Over Serial (POS) module mounted on the NEMA motherboard and electrically connected to the NEMA port, and for providing networking and power for the serial device via the NEMA port;
a mobile communication network module for providing a mobile communication network;
a Power Over Ethernet (POE) module for being coupled to the IP device and for providing networking and power for the IP device; and
a network processing module electrically connected to the mobile communication network module, the POE module and the POS module, and for allowing the mobile communication network module to provide the mobile communication network for the POE module and the POS module.

2. The NEMA edge gateway according to claim 1, further including: a streetlight dimming control module mounted on the NEMA motherboard and electrically connected to the NEMA port, and for controlling brightness of the NEMA Luminaire via the NEMA port.

3. The NEMA edge gateway according to claim 2, further including: a power supply module electrically connected to the NEMA port to receive electrical energy, wherein the electrical energy serves as a power source for the streetlight dimming control module, the POS module, the mobile communication network module, the POE module and the network processing module.

4. The NEMA edge gateway according to claim 1, further including: a network status indicating module electrically connected to the network processing module and for indicating a status of the network processing module or mobile communication network.

5. The NEMA edge gateway according to claim 1, further including: an encryption and decryption module electrically connected to the network processing module and for performing encryption and decryption on signals processed by the network processing module.

6. The NEMA edge gateway according to claim 1, wherein the network processing module includes a clock synchronization unit for performing clock synchronization on signals processed by the network processing module.

7. The NEMA edge gateway according to claim 1, wherein the mobile communication network module includes a positioning module for providing positioning information for the network processing module.

8. The NEMA edge gateway according to claim 1, wherein the mobile communication network module, the network processing module and the POE module are mounted on the NEMA motherboard.

9. The NEMA edge gateway according to claim 1, further including: a POE daughterboard, wherein the POE module is mounted on the POE daughterboard.

10. The NEMA edge gateway according to claim 9, further including: a NEMA base and a NEMA case, wherein the NEMA base carries the NEMA motherboard; the NEMA port has a coupling end exposed from the NEMA base and for being coupled to the NEMA Luminaire; and the NEMA case covers the NEMA base, and the NEMA motherboard and the POE daughterboard are stacked in layers within a receiving space formed between the NEMA case and the NEMA base.

11. The NEMA edge gateway according to claim 1, further including: a network daughterboard, wherein the mobile communication network module and the network processing module are mounted on the network daughterboard.

12. The NEMA edge gateway according to claim 1, further including: a POE daughterboard and a network daughterboard, wherein the network processing module and the POE module are mounted on the POE daughterboard, and the mobile communication network module is mounted on the network daughterboard.

13. The NEMA edge gateway according to claim 12, further including: a NEMA base and a NEMA case, wherein the NEMA base carries the NEMA motherboard; the NEMA port has a coupling end exposed from the NEMA base and for being coupled to the NEMA Luminaire; and the NEMA case covers the NEMA base, and the NEMA motherboard, the network daughterboard and the POE daughterboard are stacked in layers within a receiving space formed between the NEMA case and the NEMA base.
